(19) United States
(12) Patent Application Publication
(10) Pub. No.: US 2022/0035989 A1
(43) Pub. Date: Feb. 3, 2022

(54) PERSONALIZED PRESENTATION OF MESSAGES ON A COMPUTING DEVICE

(71) Applicant: MICROSOFT TECHNOLOGY LICENSING, LLC, Redmond, WA (US)

(72) Inventors: Dikla DOTAN-COHEN, Herzliya (IL); Ido PRINESS, Herzliya (IL); Ran BERNSTEIN, Herzliya (IL)

(21) Appl. No.: 17/501,678

(22) Filed: Oct. 14, 2021

Related U.S. Application Data
(63) Continuation of application No. 15/833,042, filed on Dec. 6, 2017.

(51) Int. Cl. G06F 40/106; H04L 12/58; G06T 11/20; H04L 29/08; G06Q 10/10

(52) U.S. Cl. CPC G06F 40/106; H04L 51/18; G06T 2200/24; H04L 67/306; G06Q 10/107; G06T 11/206

(57) ABSTRACT

Technology is disclosed for controlling the presentation of electronic messages on personal computing devices (i.e., user devices). A first electronic message is received. A determination is made whether any of a set of previously received electronic messages is related to the first electronic message. For the first electronic message, and any determined related electronic messages, a diagrammatic representation of the determined relationship of the first electronic message to the previously received electronic messages is generated for presentation on the user device, as well as identifiers indicating message relevance, message changes, and/or identification and presentation of any relevant supplemental information.

### CROSS-REFERENCE TO RELATED DOCUMENTS

This application is a continuation of prior application Ser. No. 15/833,042, filed Dec. 6, 2017, titled “PERSONALIZED PRESENTATION OF MESSAGES ON A COMPUTING DEVICE,” which is expressly incorporated by reference herein in its entirety.

### BACKGROUND

Electronic messaging is now used by many people to communicate, both in their business and personal settings. These messages are often sent to a large group of people, creating a group message thread. These group threads can become large, disorganized, or altered in such a way as to confuse the recipients. In these large threads, many of the messages may be largely irrelevant to particular recipients on the thread. Without opening each message and reviewing it, any particular recipient may not know whether the message is relevant to them, or not. Additionally, any changes that may be particularly significant to a recipient are typically only determined by the recipient, and only after a careful review of the message within the thread. As one example, large group emails may therefore clutter a user's inbox with emails that are of little relevance to the user. While the initial email could be relevant, other user replies, or created sub-threads, may have diminished relevance, or may not be relevant to the particular user at all. Without some review, however, it is difficult for users to determine which emails are relevant, are which are not.

As another example, upon receiving a group message, some people may only reply to a sub-set of the group, creating a sub-thread. But, others may not realize that this sub-thread was created. As a result, others on the sub-thread may reply to only the sub-thread, believing their reply is going to everyone on the original group thread. This can create confusion, or misunderstandings, among the group recipients. As another example, when users in a group message are replying, the sender may add people not on the original group distribution, or delete people in the original group distribution. When this happens, it can be difficult to determine the current addressees in the group without careful attention to the addressee list. Each time a person is added or deleted, the state of the group changes and raises the potential for confusion. As one further example, someone may change the subject line in a reply. As one instance of this example, the original group message may have had a misspelled word in the subject line. If someone corrects this spelling in the subject line in a reply, the thread can become fragmented. If a user later searches for messages in the thread, and sorts based on subject line, some messages will appear in a thread with the original subject line, and the sub-thread created by the spelling correction will be grouped with all others created after the spelling correction. In other instances, particular messages may, in fact, be related in some way that is not immediately apparent. These messages might not share the same subject line, or particular addressees, but may still be related.

Most email and messaging applications arrange messages in some type of linear layout, providing little information to the user. As an example, in a time-based linear layout, a user may have to open the latest email, scroll to the bottom, and then review the email from the bottom to the top to determine the context and content of the email thread. Without opening and reviewing each email, it is difficult for users to determine the overall context of the email, any particular relevance of the email, as well as any changes that may have been made to the email thread.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Embodiments described in the present disclosure are directed towards technologies for improving the presentation of electronic messages on personal computing devices (sometimes referred to herein as mobile devices or user devices). In particular, embodiments provide technology to receive a first electronic message and determine whether any of a set of previously received electronic messages are related to the first electronic message. The relatedness of any message can be based on message similarity, or message feature similarity. The system includes technology for determining a change in the first electronic message and generating a change identifier for display in the diagrammatic representation. Similarly, aspects may include determining message relevance to a user, and may include generating and displaying a relevance identifier on a diagrammatic representation. Another aspect may include determining additional information that is supplemental to the electronic messages in the thread, and generating a supplemental information message identifier for display in the diagrammatic representation. Embodiments also include generating a diagrammatic representation of the determined relationship of the first electronic message to at least one of the previously received electronic messages for presentation on the user device.

### BRIEF DESCRIPTION OF THE DRAWINGS

Aspects of the disclosure are described in detail below with reference to the attached drawing figures, wherein:

FIG. 1 is a block diagram of an example operating environment suitable for implementations of the present disclosure;

FIG. 2 is a diagram depicting an example computing architecture suitable for implementing aspects of the present disclosure;

FIG. 3 illustratively depicts an exemplary screenshot from a personal computing device showing aspects of an example graphical user interface, in accordance with an embodiment of the present disclosure;

FIG. 4 illustratively depicts a view of a diagrammatic representation of a group of related electronic messages;

FIGS. 5A and 5B depicts flow diagrams of methods for controlling presentation of messages on a computing device, in accordance with an embodiment of the present disclosure;

FIG. 6 illustratively depicts another exemplary screenshot from a personal computing device showing aspects of an example graphical user interface, in accordance with an embodiment of the present disclosure; and

FIG. 7 is a block diagram of an exemplary computing environment suitable for use in implementing an embodiment of the present disclosure.

### DETAILED DESCRIPTION

The subject matter of aspects of the present disclosure is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described. Each method described herein may comprise a computing process that may be performed using any combination of hardware, firmware, and/or software. For instance, various functions may be carried out by a processor executing instructions stored in memory. The methods may also be embodied as computer-useable instructions stored on computer storage media. The methods may be provided by a stand-alone application, a service or hosted service (stand-alone or in combination with another hosted service), or a plug-in to another product, to name a few.

Aspects of the present disclosure relate to technology for improving electronic message displays presented on personal computing devices (sometimes referred to herein as mobile devices or user devices). The coalescence of telecommunications and personal computing technologies in the modern era has enabled, for the first time in human history, near instantaneous communication with a ubiquity of personal computing resources (including mobile personal computing devices and cloud-computing coupled with communication networks). As a result, it is increasingly common for users to rely on one or more mobile computing devices throughout the day for communication based tasks. But the electronic messages, such as emails, may become dauntingly voluminous, disorganized and difficult to fully-understand. Moreover, the conventional technologies for organizing and displaying electronic messaging continue to suffer from the deficiencies described above including problems created from email threads (e.g., presenting many messages from the thread that are irrelevant to the user, corrected misspellings in subject lines that cause messages to not be presented when users search for messages in the thread, sub-threads, the addition or deletion of recipients, and other problems described herein). The progression of telecommunications and personal computing technologies has elevated time-based pressures on users to respond or act on incoming electronic messages, but have so far not provided a mechanism to determine message relevance, to highlight relevant changes, to determine relatedness, nor provide a graphic visualization the context of an electronic message, such as an email, within a group of related messages. (This is particularly so for mobile devices, which often have limited screen real estate for displaying user interfaces for electronic messaging applications.) Moreover, the conventional approaches to displaying electronic messages—such as in a typical linear, time-based layout—do not really address the issues and opportunities created by these technologies. In particular, among other benefits, embodiments described herein improve technology by determining the relatedness of electronic messages, and presenting a visualized diagrammatic representation of the context of the email message within the group of related email messages (or other electronic message) to users.

In other embodiments, solutions provided herein include technologies for improving, or providing improved control over, the presentation or display of electronic messages on computing devices. In particular, some of these technologies reveal or highlight changes or new data regarding an email in a thread. In some embodiments, the solutions provided herein present or highlight emails, summaries of emails, or portions of emails that are determined to be relevant to a user based upon a user's context, the nature of the information itself, and rules or logic indicating what information is likely considered relevant by the user. The user's context data may include, for example and without limitation, location data (e.g., the location of the mobile device or location history), which may include venue information; application (or “app”) usage; app installation; communication such as incoming or outgoing calls, texts, emails, and instant messages; information derived from applications or computing services, online activity of the user, or accounts associated with the user (e.g., email accounts, social media accounts), such as calendar events, purchases or financial transactions, social media activity, app notifications, or information from a virtual assistant associated with the user; user searches or search history; motion information such as accelerometric/gyroscopic information or motion derived from sensing changes in location information; physiological information (e.g., blood pressure or heart rate, which may be provided from a wearable mobile computing device); information characterizing a state or usage of the device, such as whether the device is likely being used by the owner or another person, or other information related to the user's current or historic activity that is detectable or otherwise determinable via device computing device or online computing service associated with the user. As described below, contextual information may also include interpretive information that is derived from other contextual information, such as determining a location venue (e.g., a particular restaurant) from location-sensor data, such sensor information from a GPS sensor or determined from nearby Wi-Fi access points. The rules or logic may include default parameters, parameters that are learned or inferred from the user or a similar user, as well as settings and preferences that a user can selectively invoke, and may further include a configuration user interface enabling a user to configure specific aspects of how the related messages, relevance identifiers, change identifiers, and/or supplemental information identifiers are presented.

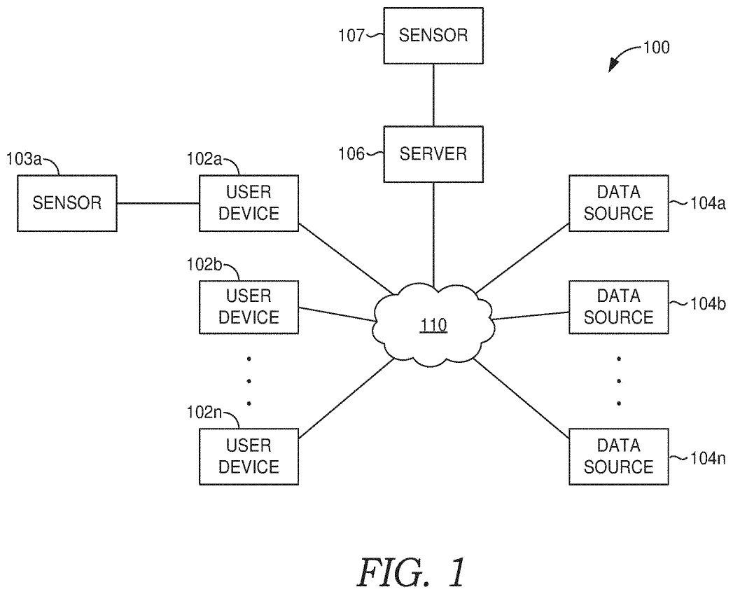

Turning now to FIG. 1, a block diagram is provided showing an example operating environment 100 in which some embodiments of the present disclosure may be employed. It should be understood that this and other arrangements described herein are set forth only as examples. Other arrangements and elements (e.g., machines, interfaces, functions, orders, and groupings of functions) can be used in addition to or instead of those shown, and some elements may be omitted altogether for the sake of clarity. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, some functions may be carried out by a processor executing instructions stored in memory.

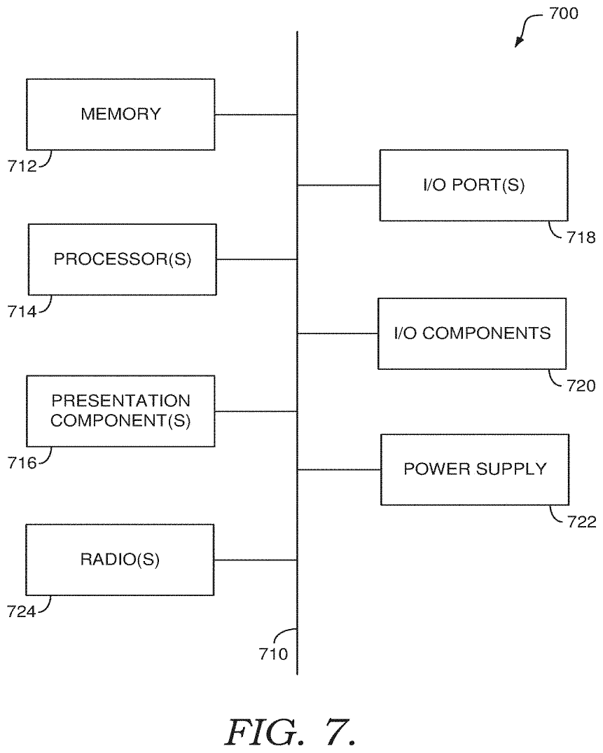

Among other components not shown, example operating environment 100 includes a number of user computing devices, such as user devices 102a and 102b through 102n; a number of data sources, such as data sources 104a and 104b through 104n; server 106; sensors 103a and 107; and network 110. It should be understood that environment 100 shown in FIG. 1 is an example of one suitable operating environment. Each of the components shown in FIG. 1 may be implemented via any type of computing device, such as computing device 700 described in connection to FIG. 7, for example. These components may communicate with each other via network 110, which may include, without limitation, one or more local area networks (LANs) and/or wide area networks (WANs). In exemplary implementations, network 110 comprises the Internet and/or a cellular network, amongst any of a variety of possible public and/or private networks.

It should be understood that any number of user devices, servers, and data sources may be employed within operating environment 100 within the scope of the present disclosure. Each may comprise a single device or multiple devices cooperating in a distributed environment. For instance, server 106 may be provided via multiple devices arranged in a distributed environment that collectively provide the functionality described herein. Additionally, other components not shown may also be included within the distributed environment.

User devices 102a and 102b through 102n can be client user devices on the client-side of operating environment 100, while server 106 can be on the server-side of operating environment 100. Server 106 can comprise server-side software designed to work in conjunction with client-side software on user devices 102a and 102b through 102n so as to implement any combination of the features and functionalities discussed in the present disclosure. This division of operating environment 100 is provided to illustrate one example of a suitable environment, and there is no requirement for each implementation that any combination of server 106 and user devices 102a and 102b through 102n remain as separate entities.

User devices 102a and 102b through 102n may comprise any type of computing device capable of use by a user. For example, in one embodiment, user devices 102a through 102n may be the type of computing device described in relation to FIG. 7 herein. By way of example and not limitation, a user device may be embodied as a personal computer (PC), a laptop computer, a mobile or mobile device, a smartphone, a smart speaker, a tablet computer, a smart watch, a wearable computer, a personal digital assistant (PDA) device, a music player or an MP3 player, a global positioning system (GPS) or device, a video player, a handheld communications device, a gaming device or system, an entertainment system, a vehicle computer system, an embedded system controller, a camera, a remote control, an appliance, a consumer electronic device, a workstation, or any combination of these delineated devices, or any other suitable computer device.

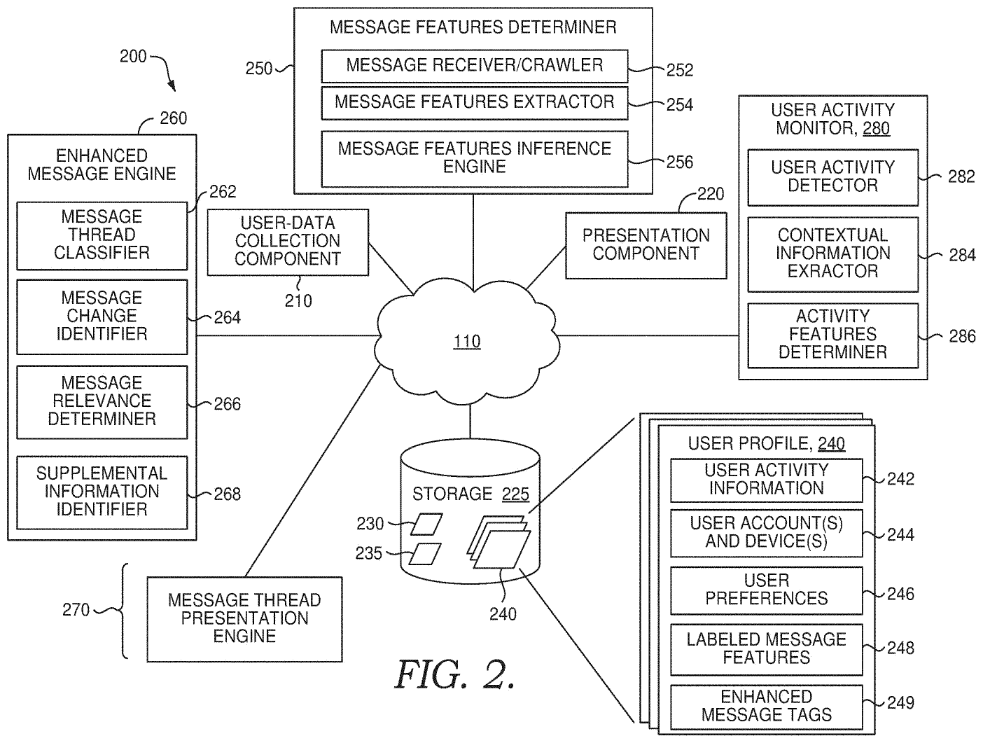

Data sources 104a and 104b through 104n may comprise data sources and/or data systems, which are configured to make data available to any of the various constituents of operating environment 100, or system 200 described in connection to FIG. 2. (For instance, in one embodiment, one or more data sources 104a through 104n provide (or make available for accessing) user data, which may include user-activity related data, to user-data collection component 210 of FIG. 2.) Data sources 104a and 104b through 104n may be discrete from user devices 102a and 102b through 102n and server 106 or may be incorporated and/or integrated into at least one of those components. In one embodiment, one or more of data sources 104a through 104n comprise one or more sensors, which may be integrated into or associated with one or more of the user device(s) 102a, 102b, or 102n or server 106. Examples of sensed user data made available by data sources 104a through 104n are described further in connection to user-data collection component 210 of FIG. 2.

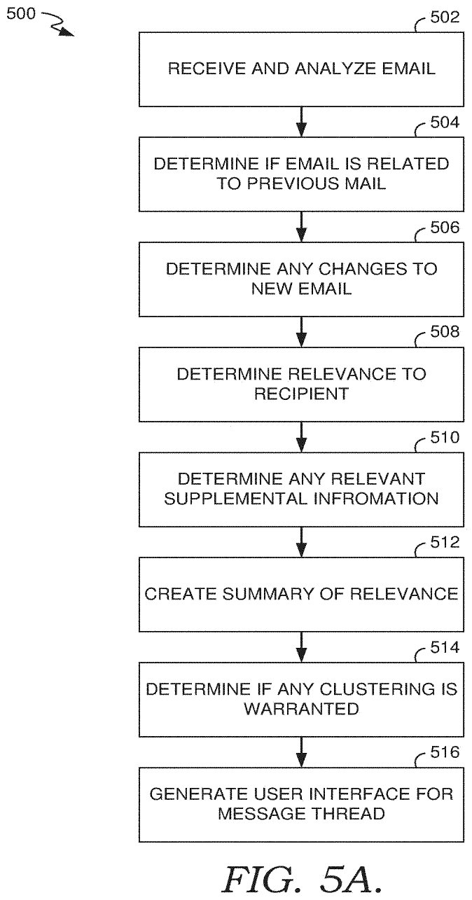

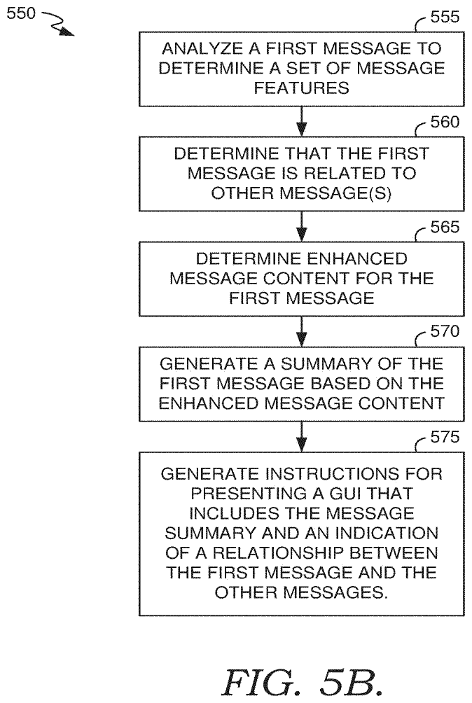

Operating environment 100 can be utilized to implement one or more of the components of system 200, described in FIG. 2, including components for collecting user data; determining message features, analyzing message relatedness, message changes, message relevance and identifying supplemental information, monitoring user activity and events, user preferences, context data, or related information; and/or presenting an enhanced message display and related content to users. Operating environment 100 also can be utilized for implementing aspects of methods 500 and 550 in FIGS. 5A and 5B.

Referring now to FIG. 2, with FIG. 1, a block diagram is provided showing aspects of an example computing system architecture suitable for implementing an embodiment of this disclosure and designated generally as system 200. System 200 represents only one example of suitable computing system architecture. Other arrangements and elements can be used in addition to or instead of those shown, and some elements may be omitted altogether for the sake of clarity. Further, as with operating environment 100, many of the elements described herein are functional entities that may be implemented as discrete or distributed components or in conjunction with other components, and in any suitable combination and location.

Example system 200 includes network 110, which is described in connection to FIG. 1, and which communicatively couples components of system 200 including user-data collection component 210, presentation component 220, message features determiner 250, enhanced message engine 260, message thread presentation engine 270, user activity monitor 280, and storage 225. User activity monitor 280 (including its components 282, 284, and 286), enhanced message engine 260 (including its components 262, 264, 266, 268 and 269), user-data collection component 210, presentation component 220, and message thread presentation engine 270 may be embodied as a set of compiled computer instructions or functions, program modules, computer software services, or an arrangement of processes carried out on one or more computer systems, such as computing device 700 described in connection to FIG. 7, for example.

In one embodiment, the functions performed by components of system 200 are associated with one or more computer messaging applications, services, or routines (such as an e-mail manager). In particular, such applications, services, or routines may operate on one or more user devices (such as user device 102a), servers (such as server 106), may be distributed across one or more user devices and servers, or be implemented in the cloud. Moreover, in some embodiments, these components of system 200 may be distributed across a network, including one or more servers (such as server 106) and client devices (such as user device 102a), in the cloud, or may reside on a user device, such as user device 102a. Moreover, these components, functions performed by these components, or services carried out by these components may be implemented at appropriate abstraction layer(s) such as the operating system layer, application layer, hardware layer, etc., of the computing system(s). Alternatively, or in addition, the functionality of these components and/or the embodiments described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein with regards to specific components shown in example system 200, it is contemplated that in some embodiments functionality of these components can be shared or distributed across other components.

Continuing with FIG. 2, user-data collection component 210 is generally responsible for accessing or receiving (and in some cases also identifying) user data from one or more data sources, such as data sources 104a and 104b through 104n of FIG. 1. In some embodiments, user-data collection component 210 may be employed to facilitate the accumulation of user data of a particular user (or in some cases, a plurality of users including crowdsourced data) for user activity monitor 280. The data may be received (or accessed), and optionally accumulated, reformatted, and/or combined, by user-data collection component 210 and stored in one or more data stores such as storage 225, where it may be available to other components of system 200. For example, the user data may be stored in or associated with a user profile 240, as described herein. In some embodiments, any personally identifying data (i.e., user data that specifically identifies particular users) is either not uploaded or otherwise provided from the one or more data sources with user data, is not permanently stored, and/or is not made available to user activity monitor 280.

User data may be received from a variety of sources where the data may be available in a variety of formats. For example, in some embodiments, user data received via user-data collection component 210 may be determined via one or more sensors (such as sensors 103a and 107 of FIG. 1), which may be on or associated with one or more user devices (such as user device 102a), servers (such as server 106), and/or other computing devices. As used herein, a sensor may include a function, routine, component, or combination thereof for sensing, detecting, or otherwise obtaining information such as user data from a data source 104a, and may be embodied as hardware, software, or both. By way of example and not limitation, user data may include data that is sensed or determined from one or more sensors (referred to herein as sensor data), such as location information of mobile device(s), properties or characteristics of the user device(s) (such as device state, charging data, date/time, or other information derived from a user device such as a mobile device), user-activity information (for example: app usage; online activity; searches; voice data such as automatic speech recognition; activity logs; communications data including calls, texts, instant messages, and emails; website posts; other user data associated with communication events; etc.) including, in some embodiments, user activity that occurs over more than one user device, user history, session logs, application data, contacts data, calendar and schedule data, notification data, social-network data, news (including popular or trending items on search engines or social networks), online gaming data, ecommerce activity (including data from online accounts such as Microsoft®, Amazon.com®, Google®, eBay®, PayPal®, video-streaming services, gaming services, or Xbox Live®), user-account(s) data (which may include data from user preferences or settings associated with a personal assistant application or service), home-sensor data, appliance data, global positioning system (GPS) data, vehicle signal data, traffic data, weather data (including forecasts), wearable device data, other user device data (which may include device settings, profiles, network-related information (e.g., network name or ID, domain information, workgroup information, connection data, Wi-Fi network data, or configuration data, data regarding the model number, firmware, or equipment, device pairings, such as where a user has a mobile phone paired with a Bluetooth headset, for example, or other network-related information)), gyroscope data, accelerometer data, payment or credit card usage data (which may include information from a user's PayPal account), purchase history data (such as information from a user's Xbox Live, Amazon.com, or eBay account), other sensor data that may be sensed or otherwise detected by a sensor (or other detector) component(s) including data derived from a sensor component associated with the user (including location, motion, orientation, position, user-access, user-activity, network-access, user-device-charging, or other data that is capable of being provided by one or more sensor components), data derived based on other data (for example, location data that can be derived from Wi-Fi, Cellular network, or IP address data), and nearly any other source of data that may be sensed or determined as described herein.

In some respects, user data may be provided in user-data streams or signals. A “user signal” can be a feed or stream of user data from a corresponding data source. For example, a user signal could be from a smartphone, a home-sensor device, a GPS device (e.g., for location coordinates), a vehicle-sensor device, a wearable device, a user device, a gyroscope sensor, an accelerometer sensor, a calendar service, an email account, a credit card account, or other data sources. In some embodiments, user-data collection component 210 receives or accesses data continuously, periodically, or as needed.

User activity monitor 280 is generally responsible for monitoring user data for information that may be used for determining user activity information, which may include identifying and/or tracking features (sometimes referred to herein as “variables”) or other information regarding specific user actions and related contextual information. Embodiments of user activity monitor 280 may determine, from the monitored user data, user activity associated with a particular user. As described previously, the user activity information determined by user activity monitor 280 may include user activity information from multiple user devices associated with the user and/or from cloud-based services associated with the user (such as email, calendars, social-media, or similar information sources), and which may include contextual information associated with the identified user activity. User activity monitor 280 may determine current or near-real-time user activity information and may also determine historical user activity information, in some embodiments, which may be determined based on gathering observations of user activity over time, accessing user logs of past activity (such as browsing history, for example). Further, in some embodiments, user activity monitor 280 may determine user activity (which may include historical activity) from other similar users (i.e., crowdsourcing), as described previously.

In some embodiments, information determined by user activity monitor 280 may be provided to message features determiner 250 and enhanced message engine 260 including information regarding the current context and historical context (historical observations). As described previously, user activity features may be determined by monitoring user data received from user-data collection component 210. In some embodiments, the user data and/or information about the user activity determined from the user data is stored in a user profile, such as user profile 240.

In an embodiment, user activity monitor 280 comprises one or more applications or services that analyze information detected via one or more user devices used by the user and/or cloud-based services associated with the user, to determine activity information and related contextual information. Information about user devices associated with a user may be determined from the user data made available via user-data collection component 210, and may be provided to user activity monitor 280, message features determiner 250, enhanced message engine 260, or other components of system 200.

More specifically, in some implementations of user activity monitor 280, a user device may be identified by detecting and analyzing characteristics of the user device, such as device hardware, software such as operating system (OS), network-related characteristics, user accounts accessed via the device, and similar characteristics. For example, information about a user device may be determined using functionality of many operating systems to provide information about the hardware, OS version, network connection information, installed application, or the like.

Some embodiments of user activity monitor 280, or its subcomponents, may determine a device name or identification (device ID) for each device associated with a user. This information about the identified user devices associated with a user may be stored in a user profile associated with the user, such as in user accounts and devices 244 of user profile 240. In an embodiment, the user devices may be polled, interrogated, or otherwise analyzed to determine information about the devices. This information may be used for determining a label or identification of the device (e.g., a device ID) so that user interaction with the device may be recognized from user data by user activity monitor 280. In some embodiments, users may declare or register a device, such as by logging into an account via the device, installing an application on the device, connecting to an online service that interrogates the device, or otherwise providing information about the device to an application or service. In some embodiments, devices that sign into an account associated with the user, such as a Microsoft® account or Net Passport, email account, social network, or the like, are identified and determined to be associated with the user.

As shown in example system 200, user activity monitor 280 comprises a user activity detector 282, contextual information extractor 284, and an activity features determiner 286. In some embodiments, user activity monitor 280, one or more of its subcomponents, or other components of system 200, such as message features determiner 250 or enhanced message engine 260, may determine interpretive data from received user data. Interpretive data corresponds to data utilized by these components of system 200 or subcomponents of user activity monitor 280 to interpret user data. For example, interpretive data can be used to provide other context to user data, which can support determinations or inferences made by the components or subcomponents. Moreover, it is contemplated that embodiments of user activity monitor 280, its subcomponents, and other components of system 200 may use user data and/or user data in combination with interpretive data for carrying out the objectives of the subcomponents described herein. Additionally, although several examples of how user activity monitor 280 and its subcomponents may identify user activity information are described herein, many variations of user activity identification and user activity monitoring are possible in various embodiments of the disclosure.

User activity detector 282, in general, is responsible for determining (or identifying) a user action or activity event has occurred. Embodiments of activity detector 282 may be used for determining current user activity or one or more historical user actions. Some embodiments of activity detector 282 may monitor user data for activity-related features or variables corresponding to user activity such as indications of applications launched or accessed, files accessed, modified, copied, etc., websites navigated to, online content downloaded and rendered or played, or similar user activities.

Additionally, some embodiments of user activity detector 282 extract from the user data information about user activity, which may include current user activity, historical user activity, and/or related information such as contextual information. (Alternatively or in addition, in some embodiments, contextual information extractor 284 determines and extracts contextual information. Similarly, in some embodiments, activity features determiner 286 extracts information about user activity, such as user-activity related features, based on an identification of the activity determined by user activity detector 282.) Examples of extracted user activity information may include app usage, online activity, searches, calls, usage duration, application data (e.g., emails, messages, posts, user status, notifications, etc.), or nearly any other data related to user interactions with the user device or user activity via a user device. Among other components of system 200, the extracted user activity information determined by user activity detector 282 may be provided to other subcomponents of user activity monitor 280, message features determiner 250 or enhanced message engine 260. For example, the user activity information may be used by enhanced message engine 260 for determining relevance of a communication message to the user, as described below. Further, the extracted user activity may be stored in a user profile associated with the user, such as in user activity information component 242 of user profile 240. (In some embodiments, user activity detector 282 or user activity monitor 280 (or its other sub components) performs conflation on the detected user activity information. For example, overlapping information may be merged and duplicated or redundant information eliminated.

In some embodiments, user activity detector 282 runs on or in association with each user device for a user. User activity detector 282 may include functionality that polls or analyzes aspects of the operating system to determine user activity related features (such as installed or running applications or file accesses and modifications, for example), network communications, and/or other user actions detectable via the user device including sequences of actions.

Contextual information extractor 284, in general, is responsible for determining contextual information related to the user activity (detected by user activity detector 282 or user activity monitor 280), such as context features or variables associated with user activity, related information, and user-related activity, and further responsible for associating the determined contextual information with the detected user activity. In some embodiments, contextual information extractor 284 may associate the determined contextual information with the related user activity and may also log the contextual information with the associated user activity. Alternatively, the association or logging may be carried out by another service. For example, some embodiments of contextual information extractor 284 provide the determined contextual information to activity features determiner 286, which determines activity features of the user activity and/or related contextual information.

Some embodiments of contextual information extractor 284 determine contextual information related to user activity such as entities identified in a user activity or related to the activity (e.g., the other party of a call conducted by the user) or a location or venue of the user device when user activity is detected. By way of example and not limitation, this may include context features such as location data; which may be represented as a location stamp associated with the activity; contextual information about the location, such as venue information (e.g., this is the user's office location, home location, school, restaurant, move theater, etc.), yellow pages identifier (YPID) information, time, day, and/or date, which may be represented as a time stamp associated with the activity; user device characteristics or user device identification information regarding the device on which the user carried out the activity; duration of the user activity, other user activity/activities preceding and/or following the user activity (which may include sequences of user activities), other information about the activity such as entities associated with the activity (e.g., venues, people, objects, etc.), information detected by sensor(s) on user devices associated with the user that is concurrent or substantially concurrent to the user activity (e.g., motion information or physiological information detected on a fitness tracking user device, listening to music, which may be detected via a microphone sensor if the source of the music is not a user device), or any other information related to the user activity that is detectable that may be used for determining patterns of user activity.

In embodiments using contextual information related to user devices, a user device may be identified by detecting and analyzing characteristics of the user device, such as device hardware, software such as operating system (OS), network-related characteristics, user accounts accessed via the device, and similar characteristics. For example, as described previously, information about a user device may be determined using functionality of many operating systems to provide information about the hardware, OS version, network connection information, installed application, or the like. In some embodiments, a device name or identification (device ID) may be determined for each device associated with a user. This information about the identified user devices associated with a user may be stored in a user profile associated with the user, such as in user account(s) and device(s) 244 of user profile 240. In an embodiment, the user devices may be polled, interrogated, or otherwise analyzed to determine contextual information about the devices. This information may be used for determining a label or identification of the device (e.g., a device ID) so that user activity on one user device may be recognized and distinguished from user activity on another user device. Further, as described previously, in some embodiments, users may declare or register a user device, such as by logging into an account via the device, installing an application on the device, connecting to an online service that interrogates the device, or otherwise providing information about the device to an application or service. In some embodiments devices that sign into an account associated with the user, such as a Microsoft® account or Net Passport, email account, social network, or the like, are identified and determined to be associated with the user.

In some implementations, contextual information extractor 284 may receive user data from user-data collection component 210, parse the data, in some instances, and identify and extract context features or variables (which may also be carried out by activity features determiner 286). Context features may be stored as a related set of contextual information associated with the user activity, and may be stored in a user profile such as in user activity information component 242. In some embodiments, the user activity information determined by user activity monitor 280, such as the activity features (which may include context features) are stored in user activity information component 242 as a user relevance model, as described below, and may be used for determining relevance of communication messages to the user, based on the user's activity. For example, if the user's activity indicates the user browses websites on certain topics, then the relevance model may include model parameters indicating that those topics are relevant to the user. Similarly, if the user activity indicates that the user is spending time working with particular file names, project names, client names, or other topics or entities, then those topics or entities may be included in the relevance model, as described further herein. In some instances, relevance model parameters corresponding to these topics or entities (or corresponding to other user activity features) may be weighted according to the frequency, amount of time, and/or recency (i.e., the “freshness” of the activity, which may be used for a decaying weighting, with more recent activity receiving a higher weight than “stale” activity that occurred farther in the past) that these topics or entities (or the other user activity features) occur in the user activity. In some cases, contextual information may be used by message thread presentation engine 270, such as for personalizing content or a user experience, such as when, where, or how to present messages, message indicators, or related content. Contextual information also may be determined from the user data of one or more users, in some embodiments, which may be provided by user-data collection component 210 in lieu of or in addition to user activity information for the particular user.

Continuing with system 200 of FIG. 2, message features determiner 250 is generally responsible for determining features of electronic messages. Electronic messages could include, for example, and without limitation, email; instant messages; direct messages; chats; social media communications, which may include tweets, posts, snaps, picture-grams, and other shared-media communications; voicemail, video-mail, mixed-media messages, and similar electronic communication formats. In some embodiments, message features determiner 250 may run on a client computing device, on server, as a distributed application across multiple devices, or in the cloud. At a high level, message features determiner may receive and electronic message, or may crawl other computer application(s) or service(s) to discover electronic messages with a message receiver/crawler 252. In other words, message receiver/crawler 252 acts as the intake for the message features determiner 250. The messages from message receiver/crawler 252 are provided to, or accessed by, a message features extractor 254. Message features extractor 254 examines each message and extracts, or parses the message for, known features. As an example, and without limitation, message features extracted by message features extractor 254 may include message recipients (including categories for those the message was sent directly to, those who were copied, or whether the message was forwarded) the state of the email (unopened, forwarded, or replied to, for example), date/time the message was sent, information derived from the content of the message, which may include the message subject line or heading (e.g., topics, entities, such as places or people, events, projects, action items, requests, files, or other information) in the message, or attachments to the message. Message features determiner 250 also includes a message features inference engine 256. Message features inference engine 256 analyzes the message, and determines contextual features of the message (such as by using data from the user data collection component 210 and/or user activity information from the user activity monitor 280 or from user activity information 242 in user profile 240). As an example, and without limitation, contextual or determined features include determining the relationship of the people involved in the message, whether the message is related to a calendar event, whether the message is related to a particular project, or a location associated with the people identified with the message. The features identified by message features extractor 254 and message features inference engine 256 are labeled and stored in user profile 240 in labeled message features 248. In some embodiments, the labeling may comprise indexing the messages according to the extracted and/or inferred message features. The labels or indices, and in some embodiments, the corresponding messages, may be stored in label messages features 248 such that the feature labels (or index) may be used to identify a set of messages based on one or more features. In some embodiments, the message features corresponding to a particular message comprise a message-feature vector, an n-dimensional vector of numerical values representing the features characterizing the message, which may be stored in label messages features 248 and made available to enhanced message engine 260 (or other components of system 200) to determine, for instance, whether two or more messages.

Enhanced message engine 260 is generally responsible for analyzing user activity information 242, information from user accounts and devices 244, user preferences 246 and labeled message features 248 to determine and provide enhanced message tags (stored in user profile 240 as enhanced message tags 249) for each electronic message. As shown in FIG. 2, enhanced message engine 260 includes message thread classifier 262, message change identifier 264, message relevance determiner 266 and supplemental information identifier 268.

Message thread classifier 262 operates as a classifier to determine if the electronic message is part of a message thread. As an example, a thread could be a set of messages that share some relation, such as a common topic, subject, theme, or participants. Message thread classifier 262 uses probabilistic calculations (using classification logic 230 in storage 225) that operate as a thread classification logic. Classification logic 230 include rules, conditions, associations, classification models, or other criteria, for comparing the features of different messages and determining a probability that two or more messages are related and thus part of a message thread. For example, in one embodiment, classification logic 230 may include identifying a set of one or more features of a first message, identifying at least a portion or subset of the set of features in a historical message, and comparing the identified subset of features in the historical message to the corresponding features in the first message in order to determine a degree of similarity among the corresponding features. In other words, a feature of the first message, such as a feature characterizing the topic or subject matter of the message, may be identified and compared to a corresponding feature of the historical message (i.e., a feature characterizing the topic or subject matter of the historical message). Based on the similarity, the first message and the historical message may be determined to be (or not to be) related and thus part of a message thread. In some embodiments, where a number of corresponding features are sufficiently similar, which may be determined using a similarity threshold which may specify, for instance, a number of features necessary to be identical and/or degree(s) of variance in feature values that are permissible in order for two corresponding features to be determined as sufficiently similar (and thus members of a message thread).

Accordingly, classification logic 230 can take many different forms depending on the particular features being compared and the mechanism(s) used to determine a degree of message feature similarity. For example, the classification logic may include training data based on message features of historical messages and used to train a neural network classifier used for determining whether a newly received message is similar to (i.e., should be classified as being related to) the historical messages. As another example embodiment, statistical clustering may be performed on feature vectors of a newly received message and historical messages to determine a set of historical messages (if any) that are similar to the newly received message. Moreover, in some embodiments, it is not necessary to compare feature vectors (or more generally to compare message features) of historical messages once the messages have been determine to be part of a thread. Rather, in these embodiments, a feature vector of the newly received message may be compared to a message-thread feature vectors (each representing a previously determined message thread or set of related messages). For instance, in one embodiment, the centroid of a cluster, which may be determined from message feature vectors of a previously determined message thread, may be used as a message-thread feature vector for performing a comparison with the feature vector of a newly received message (or a message that has not yet been analyzed for membership in a message thread by message thread classifier 262) to determine whether the newly received message should be a member of the previously determined message thread.

In some embodiments, classification logic 230 may comprise fuzzy logic, neural network, finite state machine, support vector machine, logistic regression, clustering, or machine-learning techniques, similar statistical classification processes, or combinations of these to identify and compare corresponding features to determine similarity. As one example and at a high level, classification logic 230 (and thus message thread classifier 262) can examine the subject line features of a first message, and compare it to the subject line features of other messages stored in labeled message features 248. As another high level example, using classification logic 230, message thread classifier 262 can also identify a first message as a probable member of a thread if a certain threshold is satisfied regarding the similarity of the features associated with the subject line of the first message and the features associated with the subject lines of the other (historical) messages stored in labeled message features 248, or if the subject-matter features of the first message satisfies a similarity threshold with the subject matter features of other historical messages stored in labeled message features 248.

If a message is identified as part of a thread by message thread classifier 262, message change identifier 264 determines any changes in the message from the preceding message of the thread. As an example, message change identifier 264 compares features of the current message to features of the previous message in the thread stored in labeled message features 248. As a result, message change identifier 264 could identify, for example, new people added to, or deleted from, the message thread, new information that was added (this new information could be, for example, newly added in the message, or paraphrased or repeated from a past message). Any changes identified by the message change identifier 264 can be identified and tagged.

Enhanced message engine 260 also includes message relevance determiner 266 that determines message relevance to a specific user. The message relevance determiner examines the labeled message features 248, as well as other data stored in user profile 242 (e.g., user activity information 242, user accounts and devices 244 and user preferences 246) or received from user activity monitor 280 or user-data collection component 210. As one example, the user preferences 246 may indicate that a user has specifically noted a particular feature that makes an email relevant (such as an email from a specific client, or mentioning a specific company or other topic). As another example, the user activity information 242 may indicate certain relationships between the user and others associated with a message that would raise the relevance profile of a message (for example, if the message was from a user's boss or wife). As yet another example, information from user accounts and devices, such as a calendar event, may indicate that the user has an upcoming meeting and therefore message content related to the meeting or messages from other users invited to the meeting may be deemed relevant because of their urgency.

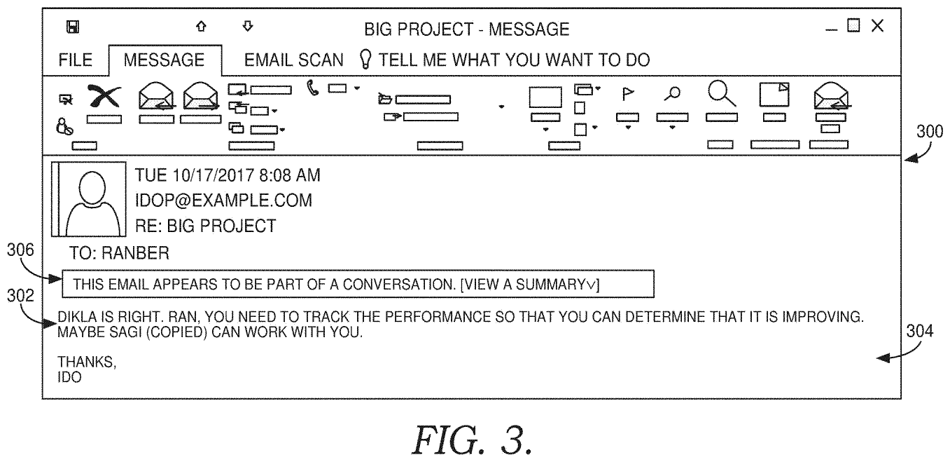

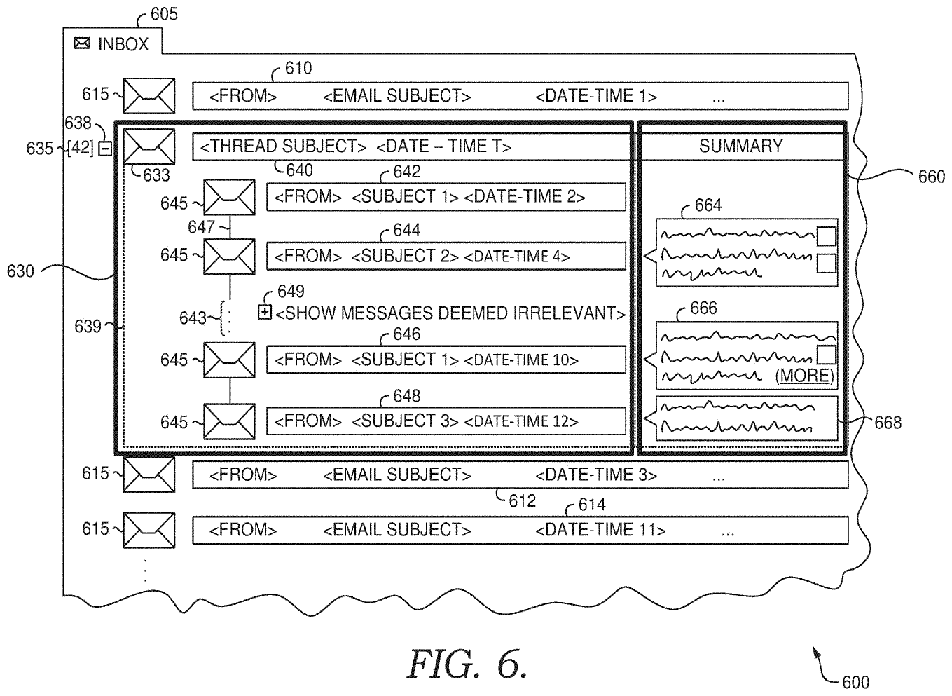

In some embodiments, message relevance determiner 266 may use relevance logic 235 (in storage 225) to examine the email thread, and messages within the email thread, to determine if they satisfy a relevance threshold. If the message satisfies the relevance threshold, the message relevance determiner 266 tags the message, or particular message feature(s) relied on for the relevance determination, as relevant with a type of relevance identifier. In some embodiments, if a message fails to satisfy the relevance threshold, the message relevance determiner 266 may tag the message as not relevant. In some embodiments, messages tagged as not relevant are clustered or grouped together and/or or hidden from the user (such as depicted at item 649 in FIG. 6). Similarly, sub-threads of messages tagged as not relevant may be clustered or grouped together (such as further described below with reference to FIG. 3) or may be hidden from the user.

Relevance logic 235 may include rules, associations, conditions, prediction (classification) models, or inference algorithms that may be used for determining a likelihood of relevance of a particular message to a user. The relevance logic 235 may take different forms depending on the particular message features (or message feature vector values) evaluated for relevance or the or the mechanism used to identify likely relevance. Relevance logic 235 may comprise fuzzy logic, neural network, finite state machine, support vector machine, logistic regression, clustering, or machine-learning techniques, similar statistical classification processes, or combinations of these to determine or infer a likelihood of relevance. For example, some embodiments of relevance logic 235 may employ machine-learning mechanisms to determine and maintain a relevance model for a user, based on observed user activity (which may be determined from user activity monitor 280). In some embodiments, the model comprises a prediction or inference model for predicting (or inferring) whether a message is likely to be relevant to the user based on its feature(s), and may further include a set of model parameters that correspond to various types of message features. In this way, message relevance determiner 266 (using relevance logic 235) may receive labeled message features (which may be in the form of a message feature vector) for a particular message, and use the relevance model to predict or infer a likelihood of relevance of the message to the user. In some instances, the relevance model may be tuned or adjusted (such as by weighting model parameters) using user preferences 246. For example, as described herein, in some instances a user may explicitly indicate, as user preferences, features that are relevant (such as message sender features indicating the message is sent by the user's boss or a client) The relevance model may be stored in a user profile 240 associated with the user. In other embodiments relevance logic 235.

Enhanced message engine 260 also includes a supplemental information identifier 268, that, in general, is responsible for determining supplemental information associated with the current email that mail be of interest to the user. Supplemental information may include helpful information, such as relevant contextual information (e.g., if a user has not interacted with a particular person in the addressee list, supplemental information might include that person's full contact information, including job title, location or other information); information from other data sources (such as content from websites or links to content useful for the user, such as a link to a website for a client mentioned in the message); or attachments relevant to the subject matter of the message (such as documents or presentation materials).

In some embodiments, the supplemental information may be determined by searching for files, searching within the user's data, and/or previous messages of the thread, to identify files that appear relevant to the message and then present those as part of the supplemental information. Also, for practical, space-saving reasons, the user interface might simply include a link or drop-down style menu that indicating supplemental information is available with some notation (for example, “see related files”). Supplemental information may also be determined from rules based on the specific message, for example, rules for providing relevant links, phone numbers, contextual background, or previous user activity undertaken that is determined likely to be relevant to the message, or other rules for providing the information described herein with regards to supplemental information. In some embodiments, supplemental information generator may determine a corresponding likelihood (using rules or logic similar to or including relevance logic 235) that a particular item of supplemental information is relevant to the message or user. Supplemental information may also be determined based on a semantic understanding, using keyword and pattern analysis, of contextual information of the message and any response information from the user's previous responses or from other users responding to similar messages, which can include user activity history (e.g., browsing history, actions taken, etc.) of other users responding to messages in the thread. Further, in some embodiments, supplemental information may be determined in a manner similar to search engine results where context features associated with the message are queried and the results used for determining or providing supplemental information.

In some embodiments, enhanced message engine 260 includes functionality for summarizing all or a portion of the subject matter content of message, such as summarizing the information determined to be relevant to a user. In particular, some embodiments of enhanced message engine 260 use rules or logic (which may be similar to classification logic 230 or relevance logic 235) to extract and/or summarize all or portions of a message. For example, a content summary may be generated from the message content corresponding to those message features determined to be relevant to the user by message relevance determiner 266. For instance, the summary may be generated using topic modeling or automatic summarization, which may include extraction or abstraction. In some embodiments, thesis or topic sentences may be identified and labeled or extracted for use in a summary. (In some embodiments, this analysis is carried out by message features determiner 250.) Similarly action items or proposals (e.g. proposed meeting times) may be identified in the message content and labeled or extracted. For example, for an email that includes an action item that is determined to be relevant to the user, the action item may be identified and tagged or labeled so that it may be presented in a summary of the message. In a similar way, the changes determined by change identifier 264 (an in particular changes that include information relevant to a user) may summarized or extracted so that they may be highlighted for the user. For example, a change identifier, representing the change or summarizing the change can be generated by enhanced message engine 260. Similarly, a relevance identifier representing the relevance or a relevance summary can be generated by the enhanced message engine 260. A supplemental information identifier (such as a link to the supplemental information, for example) can also be generated by the enhanced message engine 260.

In some embodiments, message relevance determiner 266 provides a message relevance and an associated relevance confidence score regarding the message relevance, which may reflect the likelihood that a user would find the message relevant. Similarly, supplemental information identifier provides supplemental information and an associated confidence score regarding the supplemental information, which may reflect the likelihood that the information is properly associated with the message and thus relevant to the user. More specifically, in some embodiments, a corresponding confidence weight or confidence score may be determined regarding message relevance and/or supplemental information. As one example, the confidence score may be based on the strength of the relevance, which may be determined based on the number of similar message features, types of features, and/or degree of similarity of the message features in common with other relevant messages. The relevance confidence score may correspond to the probability that the message is relevant as determined by message relevance determiner 266 using relevance logic 235. Similarly, in some embodiments, a supplemental information confidence score may be considered when providing supplemental information to message thread presentation engine 270. For example, in some embodiments, a minimum relevance or supplemental information confidence score may be needed before identifying message relevance or supplemental information. In one embodiment, a threshold of 0.6 (or just over fifty percent) is utilized such that only messages having a 0.6 (or greater) likelihood of relevance, or supplemental information having a similar likelihood of message association, may be provided.

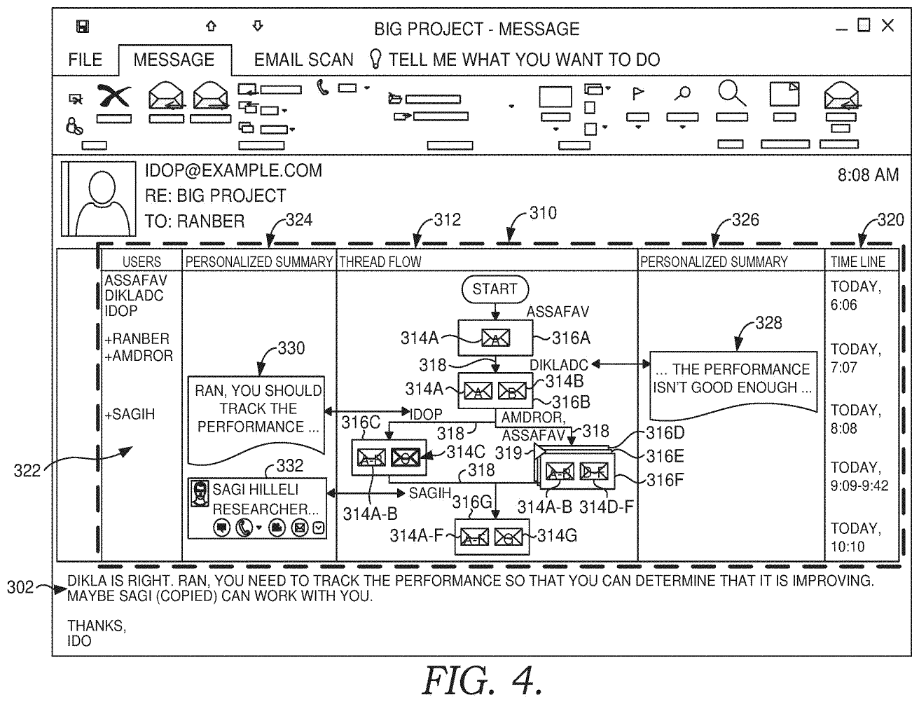

Continuing with FIG. 2, example system 200 includes a message thread presentation engine 270, which comprises applications or services that consume information from enhanced message engine 260 to coordinate with presentation component 220 to present an enhanced message display to a user, as further described below with reference to FIGS. 3, 4, and 6. At a high level, message thread presentation engine 270 is responsible for generating and providing aspects of an enhanced and personalized message display, which may include generating presentation logic and/or instructions regarding aspects of a graphical user interface. In particular, the presentation of messages to a user may be personalized via a number of ways. By way of example and not limitation, this may include presenting indicators, of messages that are determined to be part of the same message thread, within a first region of a graphical user interface that is separate from areas where other messages (or indicators of messages) are presented that are not part of the thread; depicting messages (or message indicators) that are part of the same thread within proximity to each other (as presented via a user interface); or depicting an indication of relation between messages in the same thread (such as via a message-thread diagram described in FIG. 4). For instance, a group of icons (i.e., indicators) corresponding to messages that are part of the same thread may be depicted together within a region of the user interface that is separate from other messages that are not part of the thread, which may be received over the same time period as the thread messages. As another example of the personalization of messages, various identifiers indicating change, relevance, and/or supplemental information may be presented in proximity to messages belonging to the same message thread. For instance, in one embodiment, a region of a graphical user interface, for depicting communication messages, is used to provide a summary of aspects of those messages that are within the same thread. The summary may be personalized to the user by including information determined to be relevant to the user and derived from the messages in the thread, as described herein (which may include change information or supplemental information). As yet another example, the presentation may be personalized by grouping together or hiding messages that are part of a thread, but are determined to be likely not relevant to a user. Additional details of these and other examples are described in connection to FIGS. 3, 4, and 6, which depict example embodiments enhanced message display in the form of graphical user interfaces for facilitating the personalized presentation of messages.

Example system 200 also includes a presentation component 220 that is generally responsible for presenting message displays and related information (such as supplemental information) to a user. In one embodiment, message thread presentation engine 270 may operate in conjunction with or may be implemented as one part of presentation component 220. Presentation component 220 may comprise one or more applications or services on a user device, across multiple user devices, or in the cloud. For example, in one embodiment, presentation component 220 manages the presentation of messages and message content to a user across multiple user devices associated with that user. Based on, presentation logic or instructions provided by message thread presentation engine 270, context (which may be received from user activity monitor 280), and/or other user data, presentation component 220 may determine on which user device(s) content is presented, as well as the context of the presentation, such as how (or in what format and how much content, which can be dependent on the user device or context) it is presented, when it is presented, or other such aspects of presentation.

In some embodiments, presentation component 220 generates user interface features associated with or used to facilitate presenting to the user aspects of enhanced or personalized message content (such as relevant messages in a thread or identifiers). Such features can include interface elements (such as icons or indicators, graphics buttons, sliders, menus, audio prompts, alerts, alarms, vibrations, pop-up windows, notification-bar or status-bar items, in-app notifications, or other similar features for interfacing with a user), queries, and prompts.

Example system 200 also includes storage 225. Storage 225 generally stores information including data, computer instructions (e.g., software program instructions, routines, or services), logic, profiles, and/or models used in embodiments described herein. In an embodiment, storage 225 comprises a data store (or computer data memory). Further, although depicted as a single data store component, storage 225 may be embodied as one or more data stores or may be in the cloud.

As shown in example system 200, storage 225 includes classification logic 230 and relevance logic 235, as described previously, and user profiles 240. One example embodiment of a user profile 240 is illustratively provided in FIG. 2. Example user profile 240 includes information associated with a particular user such as user activity information 242, information about user accounts and devices 244, user preferences 246, labeled message features 248, and enhanced message tags 249. The information stored in user profile 240 may be available to the message features determiner 250, enhanced message engine 260 or other components of example system 200.

As described previously, user activity information 242 generally includes user information about user actions or activity events, related contextual information, activity features, or other information determined via user activity monitor 280, and may include historical or current user activity information. User accounts and devices 244 generally includes information about user devices accessed, used, or otherwise associated with a the user, and/or information related to user accounts associated with the user, for example, online or cloud-based accounts (e.g., email, social media) such as a Microsoft® Net Passport, other accounts such as entertainment or gaming-related accounts (e.g., Xbox Live, Netflix, online game subscription accounts, etc.), user data relating to accounts such as user emails, texts, instant messages, calls, other communications, and other content; social network accounts and data, such as news feeds; online activity; and calendars, appointments, application data, other user accounts, or the like. Some embodiments of user accounts and devices 244 may store information across one or more databases, knowledge graphs, or data structures. As described previously, the information stored in user accounts and devices 244 may be determined from user-data collection component 210 or user activity monitor 280 (including one of its subcomponents).

User preferences 246 generally include user settings or preferences associated with user messaging applications. By way of example and not limitation, such settings may include user preferences about specific addressees or entities that the user considers to be relevant, and thresholds, and/or supplemental information display preferences, as described herein. As described previously, labeled message features 248 may include one or more features from messages determined by message features determiner 250. Enhanced message tags 249 include tags (and, in some embodiments, the associated messages) determined from enhanced message engine 260 discussed above.

One illustrative example implementing the system 200 is shown in FIGS. 3 and 4. The provided example is merely provided for context, and should not be seen as limiting. FIG. 3 illustrates a schematic screen shot of a message display. The message 300 of FIG. 3 was sent at 8:08 a.m. from a person (Ido) with the alias idop@example.com. The message 300 has the subject line “BIG PROJECT” and is addressed to a person with an abbreviated alias “ranber”. The message content 302 is shown in a display area 304. Immediately above the display area 304 is a notification bar 306 with an exemplary notification “This email appears to be part of a thread [View Threadv]”. The exemplary notification bar 306 is optional, and in some embodiments, the messaging application may be configured to present the thread (discussed below with respect to FIG. 4) in the first instance.

Should the user desire to view the thread, a link, button or other graphical item (such as the [View Threadv] indication) may be presented in notification bar 306 for selection by the user. FIG. 4 presents one possible display of a thread diagram 310, of which the message 300 is a part. In the thread diagram 310, the central area 312 graphically displays the thread flow of which message 300 is a part. The thread diagram 310 displays a number of email icons 314, each representing a message or messages in the thread. Each email icon 314 is selectable if the user desires to open any particular message associated with the email icon 314. The thread diagram 310 provides the user a graphical image of the state of the thread. Each email in the thread is included based on being classified as part of the message thread by message thread classifier 262. Messages may be included in the thread, for example, if they are related to the message at issue. For example, and without limitation, messages could be included in the thread by message thread classifier 262 based on similarity of subject matter, addressees, context, subject line or time. In this exemplary thread, user “assafav” initially sends an email “A” to users “dikladc” and “idop”. The first email icon 314A is represented within a node 316A in the thread diagram 310. Each node represents a state of the email thread at that point. An action between nodes is referred to as an edge, and results in a new state. In a reply to email A, “dikladc” creates an edge 318 represented in a downward arrow, resulting in a new node 316B with emails A and B, represented by email icons 314A and 314B. User “idop” then creates an edge 318 in forwarding email B to new addressee “ranber”, creating a new node 316C with email icons 314A-B (representing the email thread of emails A and B) and 314C (representing the email from “idop”). Note that the message 300 is now represented by email icon 314C which can be highlighted in some fashion to indicate it is the message 300. By selecting the email icon 314C (such as by a double-click, or a hovering action), the message 300 would be presented to the user. In addition to adding “ranber”, the email continues to copy the existing addressee “assafav”, copies new addresses “amdror” and “sagih”. Another edge 318 is created when user “amdror” and user “assafav” email back-and-forth with each other in a sub-thread, shown as nodes 316D, 316E and 316F (node 316F is shown at the top of a stack of nodes formed by nodes 316D, 316E and 316F, and contains email icons 314A-B (representing the original thread of emails A and B) and 314D-F (representing the emails D-F created by “amdror” and “assafav”). Nodes 316D, 316E and 316F are displayed as a stack. In one example, the emails D-F may have been determined by message relevance determiner 266 to be irrelevant to the user. By condensing the display of nodes 316D-316F in a stack, the message thread is less cluttered by potentially irrelevant messages. However, the stack of nodes 316D-316F is also displayed with a button 319 (shown here as a triangle) that may be selected by the user to expand the stack, and to view the nodes individually. Another edge 318 is shown when “sagih” replies to everyone, creating node 316G, containing email icons 314A-F (representing the entire thread of emails A-F), and 314G (representing the reply of “sagih”).

With continued reference to FIG. 4, an additional column 320 displays a timeline of the message thread, matching displayed times associated with each of the nodes 316. So, for example, it can be seen that the original node 316A was created today at 6:06 a.m., and node 316C was created today at 8:08 a.m. In some embodiments, another additional column 322 displays the users (or their alias or some other identifier) associated with the message thread. In the upper-most part of column 322, associated with node 316A, column 322 displays the messaging aliases for “assafav”, “dikladc”, and “idop”. In this display, the users associated with the state of a thread can be seen in a visually distinct manner. Column 322 also displays, in association with node 316B, that users “sagih”, “ranber”, and “amdror” were added to the message thread (additions here indicated with a “+” sign, but other indicators could be used as well), and that user “dikladc” was dropped from the thread (deletions here indicated with a “−” sign, but other indicators could be used as well). These changes to the message thread are identified by message change identifier 264.

FIG. 4 illustrates two other exemplary display columns 324 and 326. Column 326 displays information, for example, that is surfaced as relevant information. In the exemplary display of column 326, a relevance summary snippet 328 is shown with the snippet “the performance isn't good enough” generated from message B. As an example, the user might have specifically indicated that any messages related to performance should be considered relevant. Message relevance determiner 266 would then have tagged the message as relevant, and optionally created a summary snippet to highlight the performance aspect of the message to the user. Similarly, in the exemplary display of column 324, other message information that is determined to be relevant or supplemental information that is identified can be displayed. A first exemplary summary snippet 330 “Ran, you should track the performance . . . ” is displayed, generated from message C. Message C (and snippet 330) might be determined to be relevant because it is addressed to “Ran”, because it is coming from Ran's supervisor (“idop”) and/or because it relates to performance. It should be noted that, instead of snippets 328 and 330, more complete portions of the message might be displayed, or even the entire message. In some embodiments, some form of highlighting (such as bold text, colored text, or other indicators) may be used to indicate why the message, or portion of the message, was determined to be relevant. Column 324 also displays identified supplemental information 332. Supplemental information 332 includes summary contact information for “sagih”, who was added to the message thread by “idop”. This supplemental information 332 about “sagih” may have been identified, for example, by supplement information identifier 268 because user “sagih” was not as well known to “ranber” to whom the message was addressed. By surfacing the supplemental information 332, “ranber” can quickly learn additional details about “sagih” to provide context or understanding.

Turning to FIG. 5A, a method 500 for structuring and diagrammatically representing a message within a group of related messages for display on one or more user devices is shown. Each block or step of method 500 and other methods described herein comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a stand-alone application, a service or hosted service (stand-alone or in combination with another hosted service), or a plug-in to another product, to name a few. Accordingly, method 500 (and method 550 of FIG. 5B) may be performed by one or more computing devices, such as a smartphone or other user device, a server, or by a distributed computing platform, such as in the cloud.

Accordingly, as shown at block 502, the method 500 includes receiving and analyzing a set of electronic messages (emails). The message (or messages) may be analyzed to determining message features characterizing the message (by message features determiner 250). After a message or messages are received and analyzed to determine message features, as shown at block 504, the method includes determining if the message or messages are related to previous messages (to determine if they should be considered part of a message thread). In this step, the topics, people, context, subject line, or time (among many other possible considerations) are examined (by message thread classifier 262). If a message is classified as part of a thread, the method includes determining any changes to the message compared to the previous message or messages in the thread, as shown at block 506. Exemplary changes that might be identified at block 506 (by message change identifier 264) include added text, added or deleted addressees, and or added or deleted attachments. Method 500 continues at block 508 by determining whether the message is relevant to the user. At block 508, the overall relevance (relevant or irrelevant) is considered for the message. If a message is determined to be irrelevant, it may be tagged for possible clustering. If a message is determined to be relevant, the method, in some embodiments, includes determining the particular relevance to the user. To make this determination, for example, the message relevance determiner 266 could consider, for example, labeled message features 248, as well as user activity information 242, user accounts and devices 244 and/or user preferences 246. The method may consider, for example, a user's context (user's boss, relatives, customers, etc.), a user's interests (possibly indicated by key words or topics of interest) and or a user's activity information to determine relevance. The method 500 continues at block 510 by identifying any supplemental information associated with the message. Exemplary supplemental information could include, as examples and without limitation, relevant attachments, information about addressees in the list, or internet links. At block 512 the method 500 continues by determining whether a summary of relevance or supplemental information is warranted, and if so, creating the summary. The created summary could be several sentences, sentence fragments or extracted snippets, for example. At block 514, the method 500 includes determining if any clustering of messages in the thread is warranted. As an example, message thread presentation engine 270 might cluster messages in the thread labeled as irrelevant (in block 508).

The method 500 could also include generating the user interface for the message thread, as shown at block 516. The message thread presentation engine 270 could, for example, generate various components of a user interface for display. The method, in block 516 could utilize the outputs of method blocks 504-514 to generate the components of a user interface display. The output of block 504 could be used, for example, to create the thread diagram 310 of the exemplary screen schematic of FIG. 3. In the created thread for example, a node can be associated with the state of the email at any point in time, with an edge created by each new action. Any clusters (as determined by block 514) can be rendered in some fashion representing a cluster or stack, and can include a button or other actionable cue to the user allowing the user to expand the cluster. Any changes made to the thread (determined at block 506) can be highlighted, summarized or otherwise presented to the user on the user interface. Additionally, any information determined to be relevant (at block 510) can be highlighted, summarized or otherwise presented on the user interface. Similarly, any supplemental information identified in block 512 can be presented on the user interface.

With reference to FIG. 5B, a method 550 for diagrammatically representing and personalizing a group of related messages for display on one or more user devices is shown. As shown at block 555, the method 550 includes analyzing a first message to determine a set of message features. At block 555 a first message, such as a newly received email, is analyzed to determine one or more message features as described hererin, which characterize aspects of the first message. In some embodiments, block 255 is performed using a message features determiner 250 (FIG. 2). Additional details of analyzing messages to determine message features are described in connection to message features determiner 250.

At block 560, method 550 determines that the first message is related to one or more other messages. In some embodiments, block 550 includes comparing the message features of the first message (determined in block 555) with message features of other messages, such as previously received messages, in order to determine a likelihood that the first message is related to the other messages. For instance, in an embodiment, as messages are received, they may be analyzed to determine message features, labeled with the features, and stored. The features of a newly received message may be compared for similarity to the features of previously received messages in order to determine whether the newly received message is related to one or more previously received messages, and thus a member of a message thread. Embodiments of block 560 may be carried out using a message thread classifier 262 (FIG. 2). Additional details of analyzing messages to determine message features are described in connection to message thread classifier 262.

At block 565, enhanced message content is determined for the first message. Embodiments of block 565 may determine one or more aspects of enhanced message content for the first message, such as relevance, change, and supplemental information. In particular, a first aspect of enhanced message content includes relevance. Some embodiments of block 565 determine that the first message is relevant to the user. Relevance may be determined using message relevance determiner 266 based on a comparison of the message features (determined at block 555) and information about the user, which may be represented as a user relevance model described herein. In some embodiments of block 565, one or more message features that are relevant are identified so that a summary of the relevance may be generated for presentation to the user, based on the relevant message feature(s). Additional details of determining message relevance are described in connection to message relevance determiner 266 (FIG. 2).

Continuing with block 565, another aspect of enhanced message content includes change. Some embodiments of block 565 determine a change indicator of newly added or changed information in the first message. The new or changed information may be determined based on changes in the message feature(s) of the first message compared to the message features of the related messages. As described above with relevance, one of more of the message features identified as new or changing may be used to generate a summary of change for presentation to the user. Additional details of determining change or change identifier are described in connection to message change identifier 264 (FIG. 2). Another aspect of enhanced message content includes supplemental information. Some embodiments of block 565 determine supplemental information or a supplemental information identifier, as described herein, which includes information that supplements the first message or one or more of the related messages. Additional details of determining supplemental information are described in connection to supplemental information identifier 266 (FIG. 2).

At block 570, method 550 includes generating a summary of the first message based on the enhanced message content. Embodiments of block 570 generate a summary, which may be personalized to the user and may include an identifier of relevance, change, and/or supplemental information determined in block 565. The summary may include one or more extractions of content from the first message or abstractions (i.e., a synthesized summary) of the content, as described herein. Embodiments of block 570 may be carried out using an enhanced message engine 260 (FIG. 2). Additional details of analyzing messages to determine message features are described in connection to enhanced message engine 260.

At block 575, method 550 includes generating instructions for presenting a graphical user interface (GUI) that includes the message summary (determined at block 570) and indication of a relationship between the first message and the related other messages. The relationship between the first message and related messages may be a message thread, and the indication of a relationship in the GUI may comprise: a diagrammatic representation such as a thread diagram; a region or area of the GUI encompassing the related messages (or message indicator(s) corresponding to related messages) that is separated or distinguished from a region of the GUI for presenting unrelated messages (or message indicators corresponding to the unrelated messages); or a grouping of the related messages (or indicators corresponding to the related messages) in proximity to each other or otherwise distinguished from unrelated messages (or message indicators corresponding to the unrelated messages). The message summary may be presented in proximity to the first message (or message indicator corresponding to the first message) and/or may appear when the user hovers on or near the message or (message indicator) in some embodiments. Embodiments of block 575 may be carried out using message thread presentation engine 270 (FIG. 2). Additional details of analyzing messages to determine message features are described in connection to message thread presentation engine 270. Example GUIs that may be provided according to the instructions generated in block 575 are depicted in FIGS. 4 and 6.

Turning now to FIG. 6, another example embodiment is illustratively provided showing a diagrammatic representation of electronic messages, such as email, text, chats, or instant messages. Once again, this example is merely provided for context, and should not be seen as limiting. FIG. 6 illustrates a schematic screen shot showing aspects of an example message display graphical user interface (GUI) 600. Example GUI 600 may be presented on a computing device, such as computing device 700. As shown, example GUI 600 includes a depiction of a message inbox 605. Inbox 605 presents information about received messages such as emails, chats, instant messages, voice mails, or other forms of communication messages. Inbox 605 includes a number of UI elements 615 and 645, which are depicted as message indicators or icons, and which represent and correspond to the received communication messages. In some embodiments of GUI 600 clicking on, touching, or otherwise selecting a message indicator may cause its corresponding communication message to be displayed.

Message indicators 615 and 646 have an adjacent and corresponding message header line, such as header lines 610, 612, and 614 and header lines 642, 644, 646, and 648, which present information about each corresponding message. For example, header line 610 includes header information indicating the sender of the message (“<FROM>”), the subject of the message (“<Email subject>”) and the date and time the message was received (“<Date-Time 1>”). In particular, each of the header lines depicted in example inbox 605 displays the date-time the corresponding message was received. In this example, messages have been received at times “Date-Time 1” (shown in header line 610) through “Date-Time 12” (shown in header line 648).

Accordingly, as shown in examine GUI 600, the three instances of message indicator 615 and corresponding header lines 610, 612, and 614 are intended to represent three different communication messages, respectively, with a different header line information (and corresponding message content) for each message. Similarly, the four instances of message indicators 645 with corresponding header lines 642, 644, 646, and 648 are intended to represent four different communication messages. The date-time number depicted is intended to indicate the chronological order in which the corresponding messages were received. Thus the message corresponding to header line 614 (received at time Date-Time 11) was received before the message corresponding to header line 648 (received at time Date-Time 12). This is in contrast to conventional message display technologies which typically display messages in a chronological order from top to bottom or bottom to top, such as in the order the message are received, or display messages in a sorted order based on the same subject line, sender, or other identical message attribute. But the example embodiment of GUI 600 depicted in FIG. 6 depicts a portion of messages that are grouped together (in region 630, described below) in order to indicate a relationship, such as belonging to a message thread, and thus improves upon the conventional technologies for displaying messages.

Example GUI 600 also includes a plurality of regions or areas including a first region designated as region 630 and a second region 660. Region 630 depicts an example of a message thread diagram, which depicts an indication of relationship between a plurality of messages; for instance, the relationship may be indicated from the indicators 645 being depicted in proximity to each other and apart from other message indicators 615, from edges such as edge 647 indication a relationship connection between the indicators 645, or from distinguishing region 630 from other regions of GUI 600, such as by a border line 649 (or a color—shading, or other GUI element suitable for indicating a region boundary). In this way, a user is informed that the messages corresponding to the message indicators 645 in region 630 are part of a message thread.

The example message thread diagram depicted in region 630 includes a message thread indicator 633, which is shown to appear like message indicators 615 and 645. In some embodiments, message thread may appear different than message thread indicators 615 and 645; for example, message thread indicator 633 may be bold, a different color, or include a marking indicating that it corresponds to a message thread rather than a single message. The example message thread diagram depicted in region 630 also includes a thread header line 640, which displays information about the thread, such as a thread subject, and a date-time T. In various embodiments, the thread subject may be determined from the first message received in the thread, from the most frequently occurring message subject line (in cases where a thread contains related messages having different message subject lines, such as the example depicted in GUI 600), or subject that is derived from the content of the thread messages, such as a subject-summary of the content (e.g., “summer vacation planning 2018”) or a project name or entity name associated with the message content. Similarly, the date-time value “T” depicted in thread header line 640 may represent the date and time the first message in the thread was received by the user (or by at least one recipient in the thread), the date-time of the most recently received message, or a date-time range indicating the time interval that the thread messages were received. In some embodiments, a date-time is not depicted in the message thread header line 640.

Example GUI 600 also depicts GUI element 638, which toggles a show or hide option for displaying (or hiding) the message thread diagram depicted in region 630. For instance, in this example embodiment, selecting this toggle control 638 may collapse (or hide) the message thread diagram so that only message thread indicator 633 and thread header line 640 are shown. (Region 668, described below, would also be hidden). GUI element 635 indicates the number of messages currently in the message thread. (In this example, 42 messages are part of the message thread.)

In the example message thread diagram in region 630, only message indicators 645, and corresponding header lines (e.g., header lines 642, 644, 646, and 648), that represent messages that are determined to be relevant to the user are shown. (Relevance may be determined as described above.) As indicated by GUI elements 643 and 649, a number of other messages in this particular message thread diagram are determined to be irrelevant to the user and thus are not shown (or may be shown in a condensed form or by a single message indicator representing one or more of the irrelevant messages), despite those irrelevant messages being part of the message thread and thus related to the other messages in the thread. Specifically, some message indicators, such as message indicator 643 (or the stacked icons displayed at nodes 316D, 316E and 316F of FIG. 4) represent and correspond to one or more irrelevant messages or messages determined to be not relevant to the user. (In this example, message indicator 643 represents a plurality of messages determined to be irrelevant to the user because the message thread currently contains 42 messages, as indicated by GUI element 635.) GUI toggle 649 enables a user to selectively display (or hide) those messages in the thread that were deemed irrelevant.

A second region 660 of GUI 600 depicts enhanced message content, such as summaries of information corresponding to one or more of the thread messages in the thread diagram in region 630. In this example, three summaries (or summary snippets) 664, 666, and 668 are depicted for the messages corresponding to header lines 644, 646, and 648. As described above, the enhanced message content may be personalized to the user and include information derived from the corresponding message that is relevant to the user, change information, and/or supplemental information. For example, summary snippet 664 may include supplemental information such as files, images, biographic information about message parties or entities identified in the message content, or other types of supplemental information described herein. In some instances, summaries, such as summary snippet 666, may include a “MORE” link or GUI element enabling a user to select the element and see additional information. In some embodiments, a summary may be derived from multiple messages in the thread.

Accordingly, we have described various aspects of technology directed to systems and methods for controlling the presentation of electronic messages on personal computing devices. It is understood that various features, sub-combinations, and modifications of the embodiments described herein are of utility and may be employed in other embodiments without reference to other features or sub-combinations. Moreover, the order and sequences of steps shown in the example methods 500 and 550 are not meant to limit the scope of the present disclosure in any way, and in fact, the steps may occur in a variety of different sequences within embodiments hereof. Such variations and combinations thereof are also contemplated to be within the scope of embodiments of this disclosure.

Having described various implementations, an exemplary computing environment suitable for implementing embodiments of the disclosure is now described. With reference to FIG. 7, an exemplary computing device is provided and referred to generally as computing device 700. The computing device 700 is but one example of a suitable computing environment and is not intended to suggest any limitation as to the scope of use or functionality of embodiments of the disclosure. Neither should the computing device 700 be interpreted as having any dependency or requirement relating to any one or combination of components illustrated.

Embodiments of the disclosure may be described in the general context of computer code or machine-useable instructions, including computer-useable or computer-executable instructions, such as program modules, being executed by a computer or other machine, such as a personal data assistant, a smartphone, a tablet PC, or other handheld device. Generally, program modules, including routines, programs, objects, components, data structures, and the like, refer to code that performs particular tasks or implements particular abstract data types. Embodiments of the disclosure may be practiced in a variety of system configurations, including handheld devices, consumer electronics, general-purpose computers, or more specialty computing devices. Embodiments of the disclosure may also be practiced in distributed computing environments where tasks are performed by remote-processing devices that are linked through a communications network. In a distributed computing environment, program modules may be located in both local and remote computer storage media including memory storage devices.

With reference to FIG. 7, computing device 700 includes a bus 710 that directly or indirectly couples the following devices: memory 712, one or more processors 714, one or more presentation components 716, one or more input/output (I/O) ports 718, one or more I/O components 720, and an illustrative power supply 722. Bus 710 represents what may be one or more busses (such as an address bus, data bus, or combination thereof). Although the various blocks of FIG. 7 are shown with lines for the sake of clarity, in reality, these blocks represent logical, not necessarily actual, components. For example, one may consider a presentation component such as a display device to be an I/O component. Also, processors have memory. The inventors hereof recognize that such is the nature of the art and reiterate that the diagram of FIG. 7 is merely illustrative of an exemplary computing device that can be used in connection with one or more embodiments of the present disclosure. Distinction is not made between such categories as “workstation,” “server,” “laptop,” or “handheld device,” as all are contemplated within the scope of FIG. 7 and with reference to “computing device.”

Computing device 700 typically includes a variety of computer-readable media. Computer-readable media can be any available media that can be accessed by computing device 700 and includes both volatile and nonvolatile, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium which can be used to store the desired information and which can be accessed by computing device 700. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. Combinations of any of the above should also be included within the scope of computer-readable media.

Memory 712 includes computer storage media in the form of volatile and/or nonvolatile memory. The memory may be removable, non-removable, or a combination thereof. Exemplary hardware devices include for example solid-state memory, hard drives, and optical-disc drives. Computing device 700 includes one or more processors 714 that read data from various entities such as memory 712 or I/O components 720. Presentation component(s) 716 presents data indications to a user or other device. Exemplary presentation components include a display device, speaker, printing component, vibrating component, and the like.

The I/O ports 718 allow computing device 700 to be logically coupled to other devices, including I/O components 720, some of which may be built in. Illustrative components include a microphone, joystick, game pad, satellite dish, scanner, printer, or a wireless device. The I/O components 720 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on the computing device 700. The computing device 700 may be equipped with depth cameras, such as stereoscopic camera systems, infrared camera systems, RGB camera systems, and combinations of these, for gesture detection and recognition. Additionally, the computing device 700 may be equipped with accelerometers or gyroscopes that enable detection of motion. The output of the accelerometers or gyroscopes may be provided to the display of the computing device 600 to render immersive augmented reality or virtual reality.

Some embodiments of computing device 700 may include one or more radio(s) 724 (or similar wireless communication components). The radio transmits and receives radio or wireless communications. The computing device 700 may be a wireless terminal adapted to receive communications and media over various wireless networks. Computing device 700 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include, by way of example and not limitation, a Wi-Fi® connection to a device (e.g., mobile hotspot) that provides access to a wireless communications network, such as a WLAN connection using the 802.11 protocol; a Bluetooth connection to another computing device is a second example of a short-range connection, or a near-field communication connection. A long-range connection may include a connection using, by way of example and not limitation, one or more of CDMA, GPRS, GSM, TDMA, and 802.16 protocols.

Many different arrangements of the various components depicted, as well as components not shown, are possible without departing from the scope of the claims below. Embodiments of the disclosure have been described with the intent to be illustrative rather than restrictive. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

What is claimed is:

1. A computing system for controlling the presentation of electronic messages on one or more user devices, comprising:
one or more sensors configured to provide sensor data including user-activity related information;
one or more processors; and
computer storage memory having computer-executable instructions stored thereon which, when executed by the processor, implement a method for controlling the presentation of messages on the computing device, the method comprising:
receiving a first electronic message;
determining any of a set of previously received electronic messages that are related to the first electronic message;
generating a diagrammatic representation of the determined relationship of the first electronic message to at least one of the previously received electronic messages for presentation on the user device.

2. The system of claim 1, wherein the method further comprises:
determining a change in the first electronic message from the immediately preceding electronic message in the set of determined related electronic messages; and
generating and adding a change identifier to the generated diagrammatic representation.

3. The system of claim 1, wherein the method further comprises:
determining relevance, to a user, of the first electronic message and any of the electronic messages in the set of determined related electronic messages; and
generating a relevance identifier and adding the relevance identifier to the generated diagrammatic representation.

4. The system of claim 3, wherein the determined relevance is based, at least in part, on user features determined and stored in a user profile, characterizing aspects of a user.

5. The system of claim 4, wherein the user features are determined, at least in part, on at least one of a determined user activity and a determined user context.

6. The system of claim 1, wherein the method further comprises;
extracting, from the previously received electronic messages, a first set of message features; and
inferring, from the previously received electronic messages, a second set of message features based, at least in part, on user features determined and stored in a user profile.

7. The system of claim 1, wherein the method further comprises:
identifying supplemental information related to the first electronic message; and
generating a supplemental information identifier and adding the supplemental information identifier to the generated diagrammatic representation.

8. A method for controlling the presentation of electronic messages on one or more user devices, the method comprising:
receiving a first electronic message;
determining any of a set of previously received electronic messages that are related to the first electronic message;
generating a diagrammatic representation of the determined relationship of the first electronic message to at least one of the previously received electronic messages for presentation on the user device.

9. The method of claim 8, further comprising:
determining a change in the first electronic message from the immediately preceding electronic message in the set of determined related electronic messages; and
generating and adding a change identifier to the generated diagrammatic representation.

10. The method of claim 9, further comprising:
determining relevance, to a user, of the first electronic message and any of the electronic messages in the set of determined related electronic messages; and
generating a relevance identifier and adding the relevance identifier to the generated diagrammatic representation.

11. The method of claim 10, further comprising:
extracting, from the previously received electronic messages, a first set of message features; and
inferring, from the previously received electronic messages, a second set of message features based, at least in part, on user features determined and stored in a user profile.

12. The method of claim 11, further comprising:
identifying supplemental information related to the first electronic message; and
generating a supplemental information identifier and adding the supplemental information identifier to the generated diagrammatic representation.

13. A method for controlling a presentation of communication messages on a computing device, the method comprising:
displaying a first set of message indicators in a first demarcated region of a graphical user interface presented on the computing device, the first set of message indicators representing and corresponding to a first set of communication messages determined to be related to each other and determined to be relevant to a user of the computing device.

14. The method of claim 13, further comprising displaying in the first demarcated region of the graphical user interface a second message indicator corresponding to a second set of one or more communication messages, the second set of communication messages determined to be related to the first set of communication messages and determined to be not relevant to the user.

15. The method of claim 13:
wherein the first set of communication messages are determined to be related to each other based on an analysis of the messages to determine a set of message features for each message in the first set, and wherein a first and second message of the first set of communication messages are determined to be related to each other if the first and second message share in common at least one determined feature; and
wherein relevance of the first set of communication messages to the user is determined using a user relevance model, and wherein the user relevance model is determined at least in part based on user activity of the user.

16. The method of claim 13 further comprising presenting, in the graphical user interface, a second message indicator representing and corresponding to a second set of one or more communication messages, the second set of one or more communication messages determined to be not related to the first set of communication messages, and wherein the second message indicator is not presented within the first demarcated region of the graphical user interface.

17. The method of claim 13, further comprising displaying, in a second demarcated region of the graphical user interface presented on the computing device, an enhanced message content item corresponding to at least one message indicator in the first set of message indicators, the enhanced message content item comprising information derived from the content of the at least one message.

18. The method of claim 13, wherein the enhanced message content item comprises at least one of a change identifier summary snippet, a relevance summary snippet, or a supplemental information snippet.

19. The method of claim 13 wherein the first set of messages comprises a message thread; wherein the first set of message indicators is arranged in a message thread diagram; and wherein at least two messages of the first set of communication messages have subject lines that are not identical.

20. The method of claim 13 wherein the first region of the user interface is demarcated using a border, color, shading, or pop-up window.
